(19) United States
(12) Patent Application Publication
(10) Pub. No.: US 2024/0033716 A1
(43) Pub. Date: Feb. 1, 2024

(54) CATALYST FOR AMMONIA SYNTHESIS WITH IMPROVED ACTIVITY

(71) Applicant: CLARIANT INTERNATIONAL LTD, Muttenz (CH)

(72) Inventors: Rene ECKERT, Bad Aibling (DE); Benjamin-Louis KNIEP, Raubling (DE)

(21) Appl. No.: 18/018,283

(22) PCT Filed: Aug. 26, 2021
(86) PCT No.: PCT/EP2021/073669

§ 371 Date: Jan. 27, 2023

(30) Foreign Application Priority Data
Sep. 16, 2020 (DE) 10 2020 124 179.8

(51) Int. Cl. B01J 23/78; B01J 37/00; C01C 1/04; B01J 37/18

(52) U.S. Cl. CPC B01J 23/78; B01J 37/0081; B01J 37/0036; C01C 1/0411; B01J 37/18

(57) ABSTRACT

An iron-containing catalyst for ammonia synthesis, characterized in that it contains the promoters potassium, calcium and aluminum, wherein the proportion of potassium, calculated as K₂O, is 0.08% to 0.6% by weight, the proportion of calcium, calculated as CaO, is 0.8% to 2.2% by weight and the proportion of aluminum, calculated as Al₂O₃, is 1.0% to 2.3% by weight, is described. The invention further relates to the production of the catalyst according to the invention and to a process for ammonia synthesis using the catalyst according to the invention.

The present invention relates to an iron-containing catalyst for ammonia synthesis, characterized in that it contains the promoters potassium, calcium and aluminum, wherein the proportion of potassium, calculated as K₂O, is 0.08% to 0.6% by weight, the proportion of calcium, calculated as CaO, is 0.8% to 2.2% by weight and the proportion of aluminum, calculated as Al₂O₃, is 1.0% to 2.3% by weight. The invention further relates to the production of the catalyst according to the invention and to a process for ammonia synthesis using the catalyst according to the invention.

The synthesis of ammonia from the elements hydrogen and nitrogen represents an important large industrial scale application, by means of which important nitrogen-containing downstream products, in particular fertilizers, are obtainable. The Haber-Bosch process has established itself as the main process used here.

Ammonia is also an important building block for other sectors, for example energy storage (“power-to-ammonia”).

The catalysts used for ammonia synthesis are predominantly based on iron-containing catalysts. The iron is typically in the form of magnetite or wuestite, and the catalysts are additionally promoted with further elements. Thus, U.S. Pat. No. 5,846,507 describes the production of an ammonia catalyst whose main phase is wuestite and which was obtained by melting iron and magnetite in a resistance furnace.

Industrial scale production of the catalyst is carried out by melting the substances present in the catalyst as a mixture in an electric arc furnace or resistance furnace and then cooling and granulating the resulting melt (Ullmann's Encyclopedia of Industrial Chemistry, 2006, Chapter 4.4.1.3., pages 35-36).

CN 1235800 C describes a catalyst for ammonia synthesis containing 60% to 90% by weight of iron(II) oxide, 7% to 35% by weight of iron(III) oxide, 0.1% to 1.8% by weight of potassium oxide, 0.5% to 4.8% by weight of aluminum oxide, 0.3% to 4.7% by weight of calcium oxide, 0.1% to 3.0% by weight of titanium oxide and up to 6% by weight of other oxides.

CN 1193827 C describes a catalyst for ammonia synthesis which containing 65% to 92% by weight of iron(II) oxide, 6% to 22% by weight of Fe(III) oxide, 0.2% to 1.8% by weight of potassium oxide, 0.8% to 3.4% by weight of aluminum oxide, 0.7% to 3.8% by weight of calcium oxide, 0.1% to 1.5% by weight of at least one metal of Ti, Ru, Mo, W, V or Al and 0.2% to 2.5% of at least one oxide of Ce, Cr, Mg, Ni, W, Zr, Ti and Pd.

The catalyst described in CN 102909030 B contains 92% to 95% by weight of Fe₍₁₋ₓ₎O, where x is in the range from 0.043 to 0.09, 0.3% to 1.2% by weight of potassium oxide, 1.5% to 2.5% by weight of aluminum oxide, 1.2% to 2.5% by weight of calcium oxide, 0.4% to 1.5% by weight of magnesium oxide and 0.1% to 3.5% of at least one further oxide.

Oxygen-containing compounds such as O₂ or H₂O are catalyst poisons in ammonia synthesis. Thus, Fastrup, Catalysis Letters, 14 (1992), 233-239 describes the effect of O₂ concentration on the catalytic properties of ammonia synthesis catalyst.

There remained a need for improved iron-containing catalysts for ammonia synthesis featuring improved catalytic properties such as activity, long-term stability or stability towards catalyst poisons such as O₂ or H₂O.

This object is achieved by an iron-containing catalyst for ammonia synthesis which features the presence of the promoters K, Al and Ca in specific content ranges.

The present invention accordingly provides an iron-containing catalyst for ammonia synthesis, characterized in that it contains potassium, calculated as K₂O, in the range from 0.08% to 0.6% by weight, calcium, calculated as CaO, in the range from 0.8% to 2.2% by weight and aluminum, calculated as Al₂O₃, in the range from 1.0% to 2.3% by weight, based on the total weight of the catalyst.

The content of potassium, calculated as K₂O, is 0.08% to 0.6% by weight, preferably 0.1% to 0.5% by weight, more preferably 0.15% to 0.4% by weight, most preferably 0.15% to 0.3% by weight, based on the total weight of the catalyst.

The content of calcium, calculated as CaO, is 0.8% to 2.2% by weight, preferably 0.8% to 2.0% by weight, more preferably 1.1% to 1.8% by weight, yet more preferably 1.2% to 1.6% by weight, most preferably 1.25% to 1.55% by weight, based on the total weight of the catalyst.

The content of aluminum, calculated as Al₂O₃, is 1.0% to 2.3% by weight, preferably 1.2% to 2.0% by weight, more preferably 1.3% to 1.9% by weight, most preferably 1.35% to 1.75% by weight, based on the total weight of the catalyst.

The iron present in the catalyst according to the invention is primarily in oxidic form, typically in the form of magnetite or wuestite or a mixture thereof. In one embodiment, the proportion of wuestite in the iron compounds in the catalyst is at least 50% by weight, preferably 80% by weight, more preferably 85% by weight, more preferably 90% by weight, very particularly preferably 100% by weight. In addition to the primarily present structures such as magnetite and/or wuestite other iron compounds may also be present as secondary constituents. The proportion of these secondary constituents is typically below 10% by weight, preferably below 5% by weight, particularly preferably below 1% by weight.

The proportion of iron compounds in the catalyst according to the invention is in the range from 80.0% to 100.0% by weight, preferably in the range from 80.0% to 99.9% by weight, more preferably in the range from 90% to 99.9% by weight, particularly preferably in the range from 90.0% to 97.0% by weight, based on the total weight of the catalyst.

In addition to the promoters K, Ca and Al, other promoters may also be present in the catalyst. The proportion of these promoters, calculated as oxides, in the catalyst according to the invention is typically 0.1% to 20.0% by weight, preferably 0.1% to 10.0% by weight, particularly preferably 1.0% to 5.0% by weight, most preferably 1.5% to 2.5% by weight, based on the total weight of the catalyst.

The present invention also provides a process for producing the catalyst according to the invention.

The process is characterized by steps of:
a) mixing elemental iron, an iron-containing compound, compounds of the promoters potassium, aluminum, calcium and optionally compounds of further promoters to obtain a mixture,
b) melting the mixture obtained in step a),
c) cooling the melt from step b) to obtain a solid of the catalyst
d) comminuting the solid obtained in step c),
   wherein the compounds of the promoters potassium, calcium and aluminum are initially charged in step a) in such a way that the catalyst resulting from step d) contains potassium, calculated as K₂O, in a proportion of 0.08% to 0.6% by weight, calcium, calculated as CaO, in a proportion of 0.8% to 2.2% by weight and aluminum, calculated as Al₂O₃, in a proportion of 1.0% to 2.3% by weight.

The solid obtained after step d) may then be subjected to step of sieving to obtain catalyst granulates having a desired size distribution.

In one embodiment of the process the pulverulent starting compounds of elemental iron, the at least one iron-containing compound, the compounds of the promoters potassium, calcium and aluminum and optionally the compounds of further promoters are mixed with one another and melted at a temperature above 1500° C. in an electric arc furnace. The incandescent melt is poured out and cooled until it completely solidified. The solid catalyst is crushed using jaw crushers and/or other suitable methods. The comminuted catalyst may then be sieved to obtain catalyst granulates of a desired size distribution.

Suitable iron-containing compounds in principle include all iron compounds having an oxidation state of the iron of II and/or III. Preferred compounds are Fe₁₋ₓO where 0≤1/3, FeO, Fe₂O₃, Fe₂O₃ and Fe or mixtures thereof.

In a preferred embodiment a mixture of elemental Fe and at least one of the compounds FeO, Fe₂O₃ or Fe₃O₄, preferably a mixture of Fe and Fe₃O₄, are employed. In a preferred embodiment Fe(0) and Fe₃O₄ in the form of magnetite is at least partially converted into wuestite, wherein the proportion of wuestite in the obtained catalyst, based on the total proportion of iron compounds, is at least 50% by weight, preferably 80% by weight, more preferably at least 85% by weight, more preferably at least 90% by weight and particularly preferably 100% by weight.

Wuestite is an iron compound of molecular formula Fe₁₋ₓ0, wherein x may have values from 0 to less than ⅓, x is typically between 0.05 and 0.17.

It is particularly preferable when the catalyst is a compound comprising wuestite which is converted into Fe(0) in the reactor by reduction, typically with hydrogen.

In one embodiment the weight ratio of Fe(0) and the compound Fe₁₋ₓO, FeO, Fe₂O₃, or Fe₃O₄ in the mixture is in the range from 0.1 to 0.5, preferably 0.25 to 0.4. A preferred embodiment uses a mixture of Fe(0) and Fe₃O₄ in the form of magnetite in which the weight ratio of Fe(0) and Fe₃O₄ is in the range from 0.1 to 0.5, preferably 0.25 to 0.4.

In addition to the iron compounds the starting mixture also contains compounds of the promoters potassium, calcium and aluminum. These are initially charged such that the solid resulting from the melt contains potassium, calculated as K₂O, in a proportion of 0.08% to 0.6% by weight, preferably 0.1% to 0.5% by weight, more preferably 0.15% to 0.4% by weight, most preferably 0.15% to 0.3% by weight, calcium, calculated as CaO, in a proportion of 0.8% to 2.2% by weight, preferably 0.8% to 2.0% by weight, more preferably 1.1% to 1.8% by weight, yet more preferably 1.2% to 1.6% by weight, most preferably 1.25% to 1.55% by weight, and aluminum, calculated as Al₂O₃, in a proportion of 1.0% to 2.3% by weight, preferably 1.2% to 2.0% by weight, more preferably 1.3% to 1.9% by weight, most preferably 1.35% to 1.75% by weight, based on the total weight of the solid.

The employed compounds of the promoters potassium, calcium and aluminum are typically the corresponding oxides, hydroxides, carbonates, hydrogencarbonates or nitrates. It is preferable to employ the corresponding oxides, carbonates or nitrates.

In addition to the compounds of the promoters potassium, calcium and aluminum the starting mixture may also contain further compounds of suitable promoters. These are typically compounds of the elements V, Co, Mg, the rare earths, or a combination thereof. Preferred compounds are those of the elements V or Mg or a combination thereof.

The catalyst obtainable by the process according to the invention may subsequently be subjected to a reduction step to convert the metal compounds into the corresponding metals. This may be carried out either at room temperature or at elevated temperature, for example a temperature in the range from 150° C. to 800° C., to convert reducible metal compounds into the corresponding metals.

In one embodiment the reduction is performed by exposing the catalyst to a hydrogen-containing gas stream at a temperature in the range from 150° C. to 800° C., preferably in the range from 150° C. to 600° C.

The catalysts according to the invention may be employed in ammonia synthesis where ammonia is formed from hydrogen and nitrogen. Applications include industrial scale ammonia synthesis, for example by the Haber-Bosch process. However, the catalyst can also be used for other fields of application, for example energy storage of hydrogen in the form of ammonia.

The reaction fluid employed in ammonia synthesis contains nitrogen and hydrogen. Other gases inert under the reaction conditions, such as Ar, may also be present. In industrial scale processes for ammonia synthesis the reaction fluid may also contain catalyst poisons such as H₂O or O₂. H₂O and O₂ in particular are capable of oxidizing the reduced iron-containing catalyst and reducing its activity. In industrial scale processes for ammonia synthesis the proportion of H₂O in the reaction fluid is typically up to 100 ppmv, particularly 1 to 10 ppmv.

The present invention also provides a process for ammonia synthesis with the catalyst according to the invention. In one embodiment the reaction fluid comprises up to 100 ppmv of H₂O, preferably 1 to 10 ppmv.

The process for ammonia synthesis is typically characterized by a preceding step of reducing the catalyst. This is done by placing the catalyst in a reactor in oxidic form and passing a stream of hydrogen and nitrogen through the reactor while increasing the reactor temperature. This effects a reduction of at least the iron compound to form H₂O through elimination of oxygen. The concentration of H₂O is in a range from 100 to 5000 ppmv based on the gas stream after exiting the reactor for a duration of 12-120 h during the reduction.

The inventors have found that the catalyst according to the invention is more stable to such temporarily elevated H₂O concentrations than catalysts known from the prior art.

In one embodiment the process for ammonia synthesis therefore includes a preceding step of reducing the catalyst in which the H₂O concentration is in the range from 100 to 5000 ppmv based on the gas stream after exiting the reactor for a duration of 12-120 h.

Depending on process conditions the concentration of the H₂O can temporarily increase sharply and noticeably damage the catalyst. In a further embodiment the concentration of H₂O is therefore in a range from 2000 to 5000 ppmv based on the gas stream after exiting the reactor for a duration of 10 minutes to 8 hours during the reduction.

### BRIEF DESCRIPTION OF THE FIGURES

FIG. 1 shows the powder X-ray diffractograms of catalysts 1a to 1d, 1f to 1l and comparative catalyst 1e.

FIG. 2 shows the powder X-ray diffractograms of catalysts 2a and 2d.

FIG. 3 shows the yield of ammonia for catalyst 2a and for comparative catalyst 1e over the course of several cycles.

FIG. 4 shows the yield of ammonia for catalyst 2b and for comparative catalyst 1e as a function of reaction temperature.

FIG. 5 shows a representation of the H₂O and NH₃ concentrations generated by the catalyst 2a and the comparative catalyst 1e as a function of the temperature increase.

### EXPERIMENTAL

### Methods of Measurement

### Powder X-Ray Diffraction

Determination of the crystal structures present in the catalyst and the weight fraction thereof was by X-ray diffractometry and Rietveld refinement. For this, the sample was measured in a Bruker D4 Endeavor instrument over a range from 5 to 90° 2Θ (step sequence 0.020° 2Θ, 1.5 seconds measurement time per step). The radiation used was CuKα1 radiation (wavelength 1.54060 Å, 40 kV, 35 mA). During the measurement, the sample stage was rotated about its axis at a speed of 30 revolutions/min. The obtained diffractogram of the reflection intensities was quantitatively analyzed by Rietveld refinement and the proportion of the respective crystal structure in the sample was determined. The proportion of the respective crystal structure was determined using TOPAS version 6 software from Bruker.

### Elemental Analysis

Determination of chemical elements was by ICP analysis (inductively coupled plasma) according to DIN EN ISO 11885.

Determination of potassium was by AAS analysis (atomic absorption spectrometry) according to “E13/E14 Deutsche Einheitsverfahren zur Wasser Abwasser and Schlammuntersuchung, volume 1, 1985”.

### Example 1: Catalysts 1a to 1d, 1f to 1l and Comparative Catalyst 1e

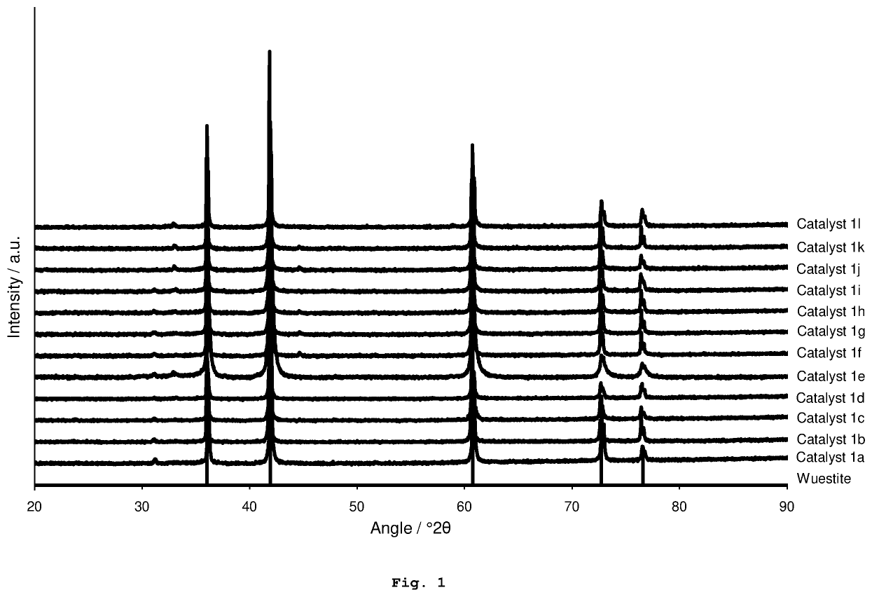

Catalysts 1a to 1d, 1f to 1l and comparative catalyst 1e were produced by mixing a mixture of magnetite and iron powder in a stoichiometric ratio of 1:1 with KNO₃, Al₂O₃ and CaCO₃ and further metal oxide-based promoters, homogenized and subsequently melted in an arc furnace, wherein for production of the catalysts 1a to 1d only the proportion of KNO₃ was varied while for the comparative catalyst 1e the proportion of Al₂O₃ was additionally varied. The proportions of K₂O, Al₂O₃ and CaO were varied for production of the catalysts 1f to 1l. Once the mixture was completely melted, the melt was cooled in a melt mold and the cooled material was converted into particles by crushing the material in a jaw crusher. The powder X-ray diffractograms of the individual catalysts are shown in FIG. 1 and show as the only iron oxide structure that of wuestite, whose reflections are likewise shown in the diffractogram for reference. The elemental compositions of the individual catalysts are shown in table 1.

TABLE 1
Content of promoters K, Al and Ca in the catalysts 1a to 1l

| | Potassium content, | Aluminum content, | Calcium content, |
|---|---|---|---|
| | calculated as K₂O, | calculated as Al₂O₃, | calculated as CaO, |
| Catalyst | in % by weight | in % by weight | in % by weight |
| 1a | 0.086 | 2.15 | 2.08 |
| 1b | 0.173 | 2.12 | 2.08 |
| 1c | 0.253 | 2.08 | 2.07 |
| 1d | 0.506 | 2.12 | 2.03 |
| 1e | 0.687 | 2.34 | 2.00 |
| 1f | 0.113 | 1.80 | 1.65 |
| 1g | 0.163 | 1.78 | 1.62 |
| 1h | 0.218 | 1.68 | 1.57 |
| 1i | 0.361 | 1.81 | 1.57 |
| 1j | 0.434 | 1.25 | 1.19 |
| 1k | 0.252 | 1.23 | 1.11 |
| 1l | 0.410 | 1.19 | 1.05 |

### Use Example 1

Inventive catalysts 1a to 1d, 1f to 1l and the comparative catalyst 1e were employed in a reaction for ammonia synthesis.

To this end, 7 g of catalyst sample in the form of the fraction having a particle diameter of 450 to 550 micrometers were charged into a reactor and at a reactor pressure of 90 bar a gas stream consisting of nitrogen (22.5% by volume), hydrogen (67.5% by volume) and argon (10% by volume) was passed therethrough. The temperature in the reactor interior was continuously increased to 520° C. and maintained at this temperature until reduction of the catalyst was complete. The pressure was then increased to 100 bar and the temperature reduced to 400° C. and these conditions were maintained for 22 hours. Once the 22 hours had elapsed the concentration of ammonia formed was detected and the temperature was subsequently increased to 520° C. and maintained for 14 hours to bring about accelerated deactivation of the catalyst. Thereafter, the procedure described above (maintaining the temperature at 400° C. for 22 h followed by increasing the temperature to 520° C. for 14 h) was repeated two further times. Ammonia concentration results are summarized in table 2.

TABLE 2
Relative ammonia space-time yields for catalysts 1a to 1l

| | Relative ammonia space-time yield per cycle [%] | | |
|---|---|---|---|
| Catalyst | cycle 1 | cycle 2 | cycle 3 |
| 1a | 91.74 | 93.98 | 95.70 |
| 1b | 97.76 | 99.31 | 100.34 |
| 1c | 98.45 | 97.25 | 97.76 |
| 1d | 100.00 | 96.21 | 96.04 |
| 1e | 96.39 | 93.29 | 92.60 |
| 1f | 91.76 | 97.01 | 98.86 |
| 1g | 99.71 | 100.93 | 100.93 |
| 1h | 100.81 | 102.30 | 102.27 |
| 1i | 101.91 | 100.34 | 98.95 |
| 1j | 99.42 | 99.72 | 98.42 |
| 1k | 90.59 | 96.34 | 98.52 |
| 1l | 98.80 | 101.81 | 102.32 |

It is apparent from table 2 that at the latest in the 2nd cycle the inventive catalysts bring about a higher yield of ammonia than the comparative catalyst and in the case of catalysts 1a, 1b, 1c, 1f, 1g, 1h, 1j, 1k and 1l activity even increases with increasing cycle duration.

### Example 2: Catalyst 2a and 2b

Catalysts 2a and 2b were produced according to the procedure in example 1, wherein the amounts of potassium, aluminum and calcium compounds were chosen such that the resulting catalysts had the following elemental composition based on the corresponding oxides:
Catalyst 2a: 0.25% by weight K₂O, 1.46% by weight CaO, 1.64% by weight Al₂O₃
Catalyst 2b: 0.31% by weight K₂O, 1.48% by weight CaO, 1.70% by weight Al₂O₃

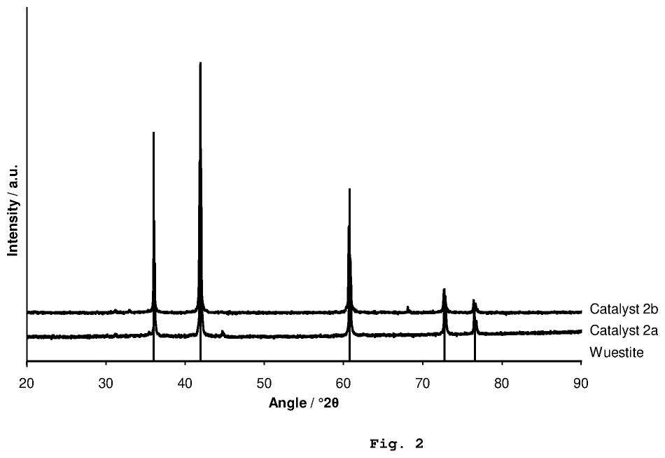

Again, wuestite was identified as the only iron oxide structure, as shown in FIG. 2. The reflections of the wuestite are likewise shown in the diffractogram for reference.

### Use Example 2

Inventive catalyst 2a and comparative catalyst 1e were employed in a reaction for ammonia synthesis.

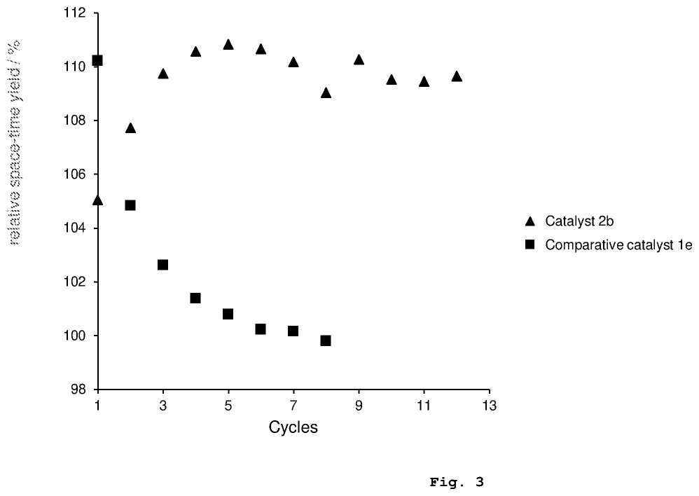

To this end, 120 g of catalyst sample in the form of a granulate having diameters of 1.5-3.0 mm were charged into a reactor and at a reactor pressure of 90 bar a gas stream consisting of nitrogen (22.5% by volume), hydrogen (67.5% by volume) and argon (10% by volume) was passed therethrough. The temperature in the reactor interior was continuously increased to 520° C. and maintained at this temperature until reduction of the catalyst was complete. The pressure was then increased to 100 bar and the temperature reduced to 400° C. and these conditions were maintained for 19 hours. Once the 19 hours had elapsed the concentration of ammonia formed was detected and the temperature was subsequently increased to 520° C. and a pressure of 150 bar and maintained for 10 hours to bring about accelerated deactivation of the catalyst. Thereafter, the procedure described above (maintaining the temperature at 400° C. and 100 bar for 19 h followed by increasing the temperature to 520° C. and 150 bar for 10 h) was repeated eleven further times for catalyst 2a and seven further times for comparative catalyst 1e. Ammonia concentration results are summarized in FIG. 3.

### Use Example 3

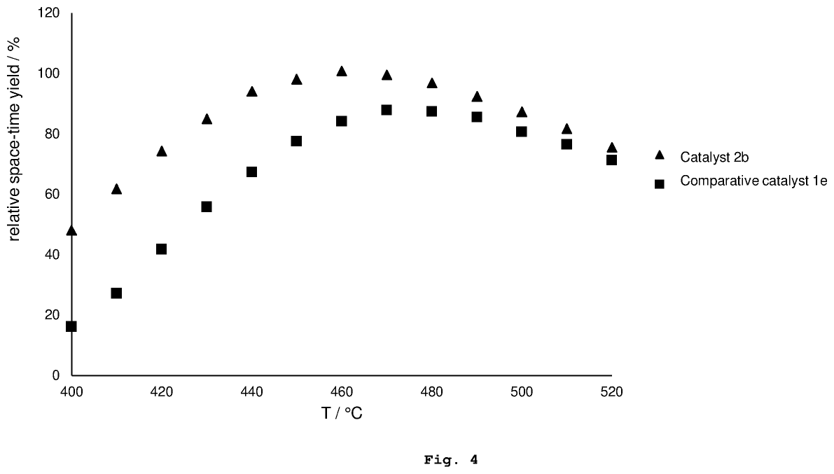

Catalyst 2b and comparative catalyst 1e were tested in a process for ammonia synthesis in which the employed gas mixture additionally contained H₂O. To this end, 120 g of catalyst sample in the form of a granulate having diameters of 1.5-3.0 mm were charged into a reactor and at a reactor pressure of 90 bar a gas stream consisting of nitrogen (22.5% by volume), hydrogen (67.5% by volume), 80 ppmv of H₂O and argon (balance to 100% by volume) was passed therethrough. The temperature in the reactor interior was continuously increased to 520° C. and maintained at this temperature until reduction of the catalyst was complete. The pressure was then increased to 100 bar and the temperature reduced to 400° C. and these conditions were maintained for 24 hours. Once the 24 hours had elapsed the concentration of ammonia formed was detected. This test was repeated for different reaction temperatures, wherein each temperature stage was held for 8 h. Ammonia concentration results are summarized in FIG. 4.

### Use Example 4

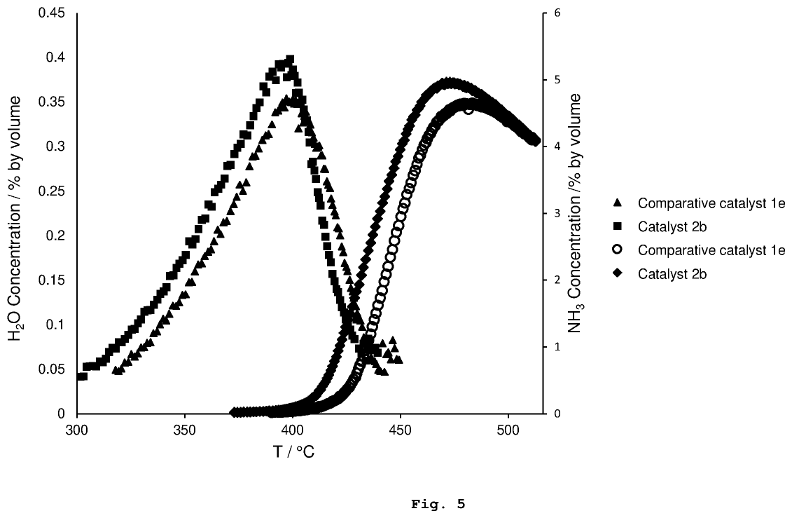

Catalyst 2b and comparative catalyst 1e were tested in respect of their reduction behavior. To this end, 120 g of catalyst sample in the form of a granulate having diameters of 1.5-3.0 mm were charged into a reactor and at a reactor pressure of 90 bar a gas stream consisting of nitrogen (22.5% by volume), hydrogen (67.5% by volume) and argon (10% by volume) was passed therethrough. The temperature in the reactor interior was continuously increased to 520° C. and maintained at this temperature until reduction of the catalyst was complete. The progress of the reduction is shown in FIG. 5. This shows a plot of water concentration and ammonia concentration as a function of the temperature inside the catalyst bed. It is apparent that the inventive catalyst 2a is reduced to the metallic state more quickly than the comparative catalyst 1e, as apparent from an earlier increase in the water concentration. Since the reduced state is achieved more quickly, catalyst 2a can also achieve earlier conversion of a portion of the nitrogen and hydrogen present in the gas stream into ammonia. Due to the improved reduction behavior of the inventive catalyst, ammonia synthesis may be performed with considerable time savings on the industrial scale too.

1. An iron-containing catalyst for ammonia synthesis, wherein it contains the promoters potassium, calculated as K₂O, in the range from 0.8% to 0.6% by weight, calcium, calculated as CaO, in the range from 0.8% to 2.2% by weight and aluminum, calculated as Al₂O₃, in the range from 1.0% to 2.3% by weight, based on the total weight of the catalyst.

2. The catalyst as claimed in claim 1, wherein it contains potassium, calculated as K₂O, in the range from 0.1% to 0.5% by weight, more preferably 0.15% to 0.4% by weight, most preferably 0.15% to 0.3% by weight, calcium, calculated as CaO, in the range from 0.8% to 2.0% by weight, more preferably 1.1% to 1.8% by weight, more preferably 1.2% to 1.6% by weight, most preferably 1.25% to 1.55% by weight, and aluminum, calculated as Al₂O₃, in the range from 1.2% to 2.0% by weight, more preferably 1.3% to 1.9% by weight, most preferably 1.35% to 1.75% by weight, based on the total weight of the catalyst.

3. The catalyst as claimed in claim 1, wherein the proportion of iron compounds is in the range from 80.0% to 100.0% by weight, preferably in the range from 80.0% to 99.9% by weight, more preferably in the range from 90% to 99.9% by weight, particularly preferably in the range from 90.0% to 97.0% by weight, based on the total weight of the catalyst.

4. The catalyst as claimed in claim 1, wherein the proportion of wuestite in the iron compounds in the catalyst is at least 50% by weight, preferably 80% by weight, more preferably 85% by weight, more preferably 90% by weight, very particularly preferably 100% by weight.

5. The catalyst as claimed in claim 1, wherein the catalyst contains a proportion of further promoters, calculated as oxides, of 0.1% to 20.0% by weight, preferably 0.1% to 10.0% by weight, particularly preferably 1.0% to 5.0% by weight, most preferably 1.5% to 2.5% by weight, based on the total weight of the catalyst.

6. A process for producing a catalyst according to any of the preceding claims, by:
a) mixing elemental iron, an iron-containing compound, compounds of the promoters potassium, aluminum, calcium and optionally compounds of further promoters to obtain a mixture,
b) melting the mixture obtained in step a),
c) cooling the melt from step b) to obtain a solid of the catalyst
d) comminuting the solid obtained in step c),
wherein the compounds of the promoters potassium, calcium and aluminum are initially charged in step a) in such a way that the catalyst resulting from step d) contains potassium, calculated as K₂O, in a proportion of 0.08% to 0.6% by weight, calcium, calculated as CaO, in a proportion of 0.8% to 2.2% by weight and aluminum, calculated as Al₂O₃, in a proportion of 1.0% to 2.3% by weight, based on the total weight of the catalyst.

7. The process as claimed in claim 6, wherein the melting in step b) is carried out in an electric arc furnace.

8. The process as claimed in claim 6, wherein the iron-containing compound is FeO, Fe₂O or Fe₃O₄, preferably Fe₃O₄.

9. The process as claimed in claim 6, wherein the employed compounds of the promoters potassium, calcium and aluminum are the corresponding oxides, hydroxides, carbonates, hydrogencarbonates or nitrates, preferably the corresponding oxides, carbonates or nitrates.

10. The process as claimed in claim 6, wherein compounds of the promoters V, Co, Mg, the rare earths, or a combination thereof, preferably compounds of V or Mg or a combination thereof, are added in step a).

11. A process for ammonia synthesis using a catalyst as claimed in claim 1.

12. The process as claimed in claim 11, wherein the reaction fluid contains up to 100 ppmv, preferably 1 to 10 ppmv, of gaseous H₂O.

13. The process as claimed in claim 11, wherein said process includes a preceding step of reducing the catalyst during which the concentration of H₂O is in a range from 100 to 5000 ppmv based on the stream that has exited the reactor for a duration of 12-120 h.

14. The process as claimed in claim 13, wherein the concentration of H₂O is 2000 to 5000 ppmv based on the stream that has exited the reactor for a duration of 10 minutes to 8 hours during the reduction.
